(19) United States
(12) Patent Application Publication
(10) Pub. No.: US 2002/0145843 A1
(43) Pub. Date: Oct. 10, 2002

(54) Protection circuit for two-wire electrical devices

(76) Inventors: Aida I Parada, Juarez (MX); Arquimedes Godoy, Juarez (MX)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 09/827,051

(22) Filed: Apr. 5, 2001

(51) Int. Cl. H02H 3/20

(52) U.S. Cl. 361/111; 361/91.5; 307/9.1

(57) ABSTRACT

A protection circuit for two-wire electrical devices is used to protect two-wire electrical devices within a motor vehicle from transient signals caused by a power supply. An input terminal lead and an output terminal lead are connected to the two wire device. A capacitor is connected across the terminal leads parallel to the two wire device. A bi-directional fast acting Zener diode array is connected from the input terminal lead to the vehicle chassis to provide a virtual ground to the two-wire device. Accordingly, the electrical conduction of the diode array protects the two-wire device from any transient signals from the power supply.

### TECHNICAL FIELD

The present invention relates generally to sensors and actuators.

### BACKGROUND OF THE INVENTION

Modern motor vehicles are equipped with numerous control systems, e.g., anti-lock brake systems, ride control systems, traction control systems, and air bag deployment systems, that provide comfort and safety to drivers and passengers of these vehicles. Each of these systems require numerous sensors and actuators that are used to determine relative part-to-part motion and control the interaction of the components within the systems. Many of these sensors and actuators are two-wire devices.

The terminal leads of these two-wire devices are designed to be used as an input and an output connected to a control module that sends signals to or interprets signals from the two-wire device. Unfortunately, as recognized by the present invention, these two-wire devices lack a direct ground path which results in a lack of protection against transient signals, e.g., voltage spikes, that may act on the two-wire devices. The circuitry within the control modules connected to the two-wire devices can be modified to provide the necessary protection, but the modification is relatively expensive.

The present invention has recognized the above drawbacks, and has provided the below-disclosed solutions to one or more of these deficiencies.

### SUMMARY OF THE INVENTION

The present invention is a protection circuit for a two-wire device installed in a motor vehicle. The two-wire device includes an input terminal lead and an output terminal lead, at least one of which is connected to a power supply. The protection circuit protects the two-wire device from transient signals from the power supply. Accordingly, the protection circuit includes a diode that electrically connects the input terminal lead to a vehicle chassis.

In a preferred embodiment, the diode is an array that includes a dual-junction common cathode of fast acting Zener diodes. Preferably, the protection circuit includes a capacitor that connects the input terminal lead to the output terminal lead. Moreover, the protection circuit includes a resistor that is installed along the input terminal lead.

In another aspect of the present, a method for protecting a two-wire electrical device in a motor vehicle from transient signals includes connecting an input terminal lead of the electrical device to ground with at least one diode array.

In yet another aspect of the present invention, a vehicle electrical system includes a two-wire electrical device, a power supply electrically connected to the two-wire electrical device, and a vehicle chassis. A diode array electrically connects the two-wire electrical device to a vehicle chassis.

The present invention will now be described, by way of example, with reference to the accompanying drawings, in which:

### BRIEF DESCRIPTION OF THE DRAWINGS

FIG. 1 is a plan view of a motor vehicle; and

FIG. 2 is circuit diagram representing a protection circuit for a two-wire device.

### DESCRIPTION OF AN EMBODIMENT OF THE INVENTION

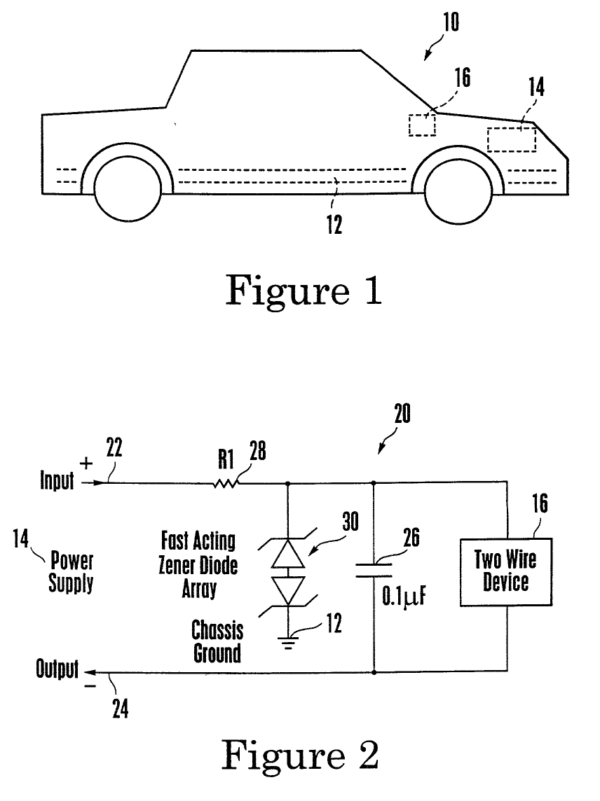

Referring initially to FIG. 1, a motor vehicle is shown and generally designated 10. As shown in FIG. 1, the motor vehicle 10 includes a chassis 12, a power supply 14, and at least one two-wire electrical device 16, e.g., a two-wire sensor or two-wire actuator.

FIG. 2 shows a protection circuit, generally designated 20. The protection circuit 20 includes an input terminal lead 22 and an output terminal lead 24. As shown in FIG. 2, each terminal lead 22, 24 is connected to the two wire device 16. A capacitor 26 is connected parallel to the two wire device 16 from the input terminal lead 22 to the output terminal lead 24. Moreover, a resistor 28 is located along the input terminal lead 22.

As shown in FIG. 2, a bi-directional diode array 30 is connected between the input terminal lead 22 and the vehicle chassis 12, which acts as a ground. In a preferred embodiment, the diode array 30 is a common cathode array of fast Zener diodes. It is to be understood that the connection of the input terminal lead 22 to the vehicle chassis 12 by the bi-directional diode array 30 provides a virtual ground to the two-wire device 16. As such, the electrical conduction of the bi-directional diode array 30 protects the two-wire device 16 from any transient signals from the power supply 14.

With the configuration of structure described above, it is to be appreciated that the protection circuit for two-wire electrical devices provides a means for protecting a two-wire electrical device in a motor vehicle from transient signals.

While the particular PROTECTION CIRCUIT FOR TWO-WIRE ELECTRICAL DEVICES as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

We claim:

1. A protection circuit for at least one two-wire device for a motor vehicle having a chassis, the two-wire device having an input terminal lead and an output terminal lead, at least one terminal lead being connected to a power supply, the protection circuit comprising:
at least one diode array being adapted for electrically connecting the input terminal lead to the chassis.

2. The circuit of claim 1, wherein the diode array is a common cathode array of Zener diodes.

3. The circuit of claim 1, further comprising:
a capacitor connected from the input terminal lead to the output terminal lead.

4. The circuit of claim 1, further comprising:
a resistor installed along the input terminal lead.

5. A method for protecting a two-wire electrical device in a motor vehicle from transient signals, the method comprising the acts of:
connecting an input terminal lead of the electrical device to ground with at least one diode array.

6. The method of claim 5, wherein the diode array is a common cathode array of Zener diodes.

7. The method of claim 5, further comprising the act of:
connecting a capacitor from the input terminal lead to an output terminal lead.

8. The method of claim 5, further comprising the act of:
installing a resistor along the input terminal lead.

9. The method of claim 5, wherein the two-wire electrical device is installed in a motor vehicle and the ground is a vehicle chassis.

10. A vehicle electrical system, comprising:
at least one two-wire electrical device;
at least one power supply electrically connected to the two-wire electrical device;
at least one vehicle chassis; and
at least one diode array electrically connecting the two-wire electrical device to the vehicle chassis.

11. The circuit of claim 10, wherein the diode array is a common cathode array of Zener diodes.

12. The circuit of claim 11, wherein the two-wire device includes an input terminal lead and an output terminal lead and the diode array connects the input terminal lead to the vehicle chassis.

13. The circuit of claim 12, further comprising:
a capacitor connected from the input terminal lead to the output terminal lead.

14. The circuit of claim 13, further comprising:
a resistor installed along the input terminal lead.
